(19) United States
(12) Patent Application Publication
(10) Pub. No.: US 2017/0303761 A1
(43) Pub. Date: Oct. 26, 2017

(54) AUTOMATIC CLEANING SYSTEM AND OPERATION METHOD THEREOF

(71) Applicant: QNAP SYSTEMS, INC., New Taipei City (TW)

(72) Inventor: Tien-Lung Chang, New Taipei City (TW)

(21) Appl. No.: 15/203,811

(22) Filed: Jul. 7, 2016

(30) Foreign Application Priority Data
Apr. 25, 2016 (TW) 105112808

(51) Int. Cl. A47L 11/40; G05D 1/02

(52) U.S. Cl. CPC A47L 11/4002; G05D 1/0238; G05D 1/0219; G05D 1/0225; G05D 2201/0203

(57) ABSTRACT

An automatic cleaning system and an operation method thereof are provided. The automatic cleaning system includes a monitor sensor, a clean robot and a controller. The monitor sensor is disposed on a field and used for monitoring the field to obtain an image. The controller is coupled to the monitor sensor to receive the image, used for analyzing the image to find out an action hot area, and instructs the clean robot to clean the action hot area.

### CROSS-REFERENCE TO RELATED APPLICATION

This application claims the priority benefit of Taiwan application serial no. 105112808, filed on Apr. 25, 2016. The entirety of the above-mentioned patent application is hereby incorporated by reference herein and made a part of this specification.

### BACKGROUND OF THE INVENTION

### Field of the Invention

The present invention relates to an automatic system, and particularly relates to an automatic cleaning system and operation method thereof.

### Description of Related Art

In recent years, the vigorous development in the computer field and the improvement of technology make plenty of automation equipment, for example, washing machine, dishwasher and clean robot, etc., be applied to people's daily lives. In order to facilitate the design, the searching path of a clean robot usually sets by simple rules so as to possibly exist unclean areas. Moreover, a clean robot usually starts at fixed times. It is unable to adjust according to the user habits and then it may disturb the user. Furthermore, a clean robot usually operates independently that means under the circumstances of a plurality of clean robots, they cannot assist each other, thereby making the overall cleaning efficiency unable to increase. Based on the above, a clean robot may have the aforementioned defects under independently operating circumstances. Therefore, how to optimize the use of clean robot becomes the focus of development.

### SUMMARY OF THE INVENTION

The invention provides an automatic cleaning system and operation method thereof which can effectively perform cleaning to a field.

The automatic cleaning system of the invention includes a monitor sensor, a clean robot and a controller. The monitor sensor is disposed on a field and used for monitoring the field to obtain an image. The controller is coupled to the monitor sensor to receive the image, used for analyzing the image to find out an action hot area, and instructs the clean robot to clean the action hot area.

The operation method of the automatic cleaning system includes the following steps. Through a monitor sensor monitoring a field to obtain an image. Through a controller analyzing the image to find out an action hot area in the field. In addition, through the controller instructing the clean robot to clean the action hot area.

Based on the above, an automatic cleaning system and operation method thereof according to the embodiments of the invention through a monitor sensor to obtain an image of a field. In addition, through a controller to find out an action hot area in the field and then the controller instructs a clean robot to clean the action hot area. In this way, the clean robot can fully and effectively perform cleaning to the field and cleaning paths of clean robot can be more flexible.

In order to make the aforementioned and other features and advantages of the invention more comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A and FIG. 1B are system schematic diagrams illustrating an automatic cleaning system according to an embodiment of the invention.

FIG. 2 is a schematic diagram illustrating a clean robot operating independently according to an embodiment of the invention.

FIG. 3 is a schematic diagram illustrating a clean robot operating jointly according to an embodiment of the invention.

FIG. 4 is an operation schematic diagram illustrating an automatic cleaning system according to an embodiment of the invention.

FIG. 5 is a flow chart illustrating an operation method of an automatic cleaning system according to an embodiment of the invention.

FIG. 6 is a flow chart illustrating an operation method of an automatic cleaning system according to another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

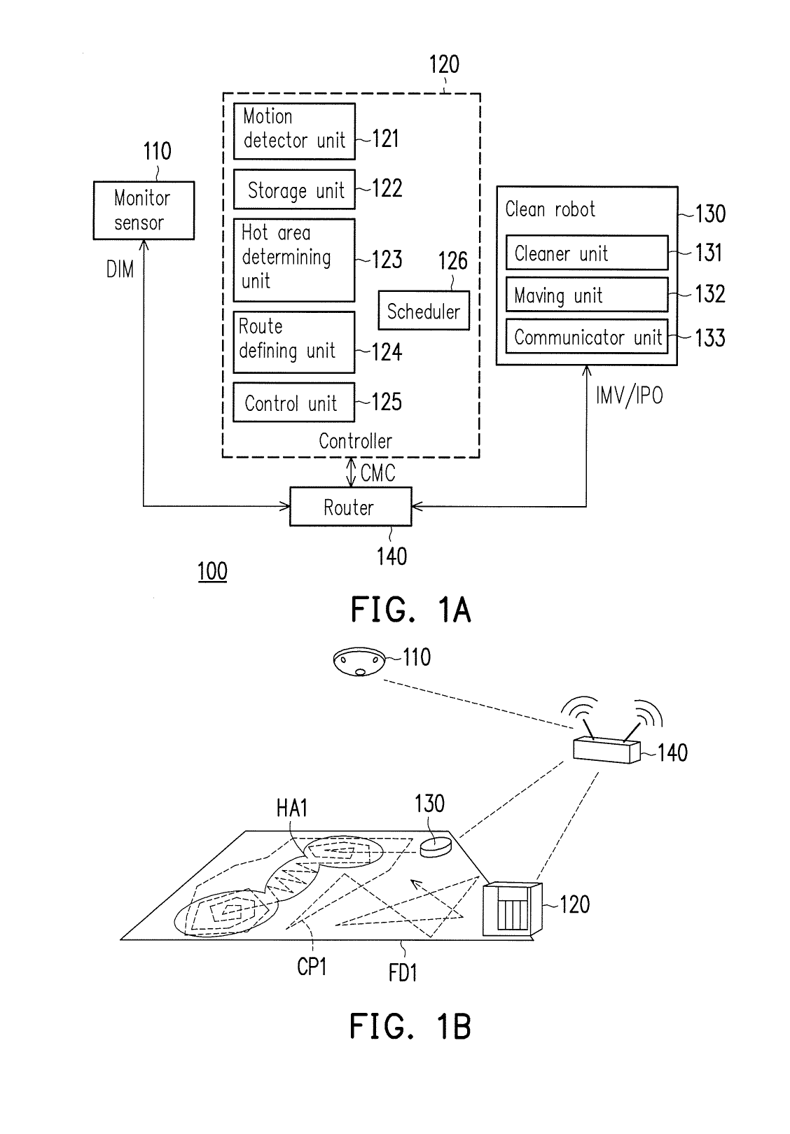

FIG. 1A and FIG. 1B are system schematic diagrams illustrating an automatic cleaning system according to an embodiment of the invention. Referring to FIG. 1A and FIG. 1B, in the present embodiment, the automatic cleaning system 100 includes a monitor sensor 110, a controller 120, a clean robot 130 and a router 140. The router 140 can be coupled to the monitor sensor 110 and the controller 120 by one of the wired interface and the wireless interface. In addition, the router 140 can also be coupled to the clean robot 130 through the wireless interface to transmit the signal (for example, the image information DIM, the mobile information IMV, the power information IPO and the control signal CMC) among the monitor sensor 110, the controller 120 and the clean robot 130.

The monitor sensor 110 is disposed on a field FD1 and used for monitoring the field FD1 to obtain an image, moreover, correspondingly provides the image information DIM. Herein, the monitor sensor 110, for example, is a camera or similar element. In addition, the monitor sensor 110 can be disposed on the top (such as the ceiling or the wall) of the field FD1 to facilitate monitoring the field FD1. Moreover, the field FD1 can be indoor space, outdoor space or half-indoor space. The controller 120 is coupled to the monitor sensor 110 and the clean robot 130, and receives the image transmitting from the image information DIM, wherein the controller 120, for example, is the website server or similar equipment. Next, the controller 120 analyzes the image of the image information DIM to find out an action hot area HA1 in the field FD1, and instructs the clean robot 130 to clean the action hot area HA1. Herein, the traveling manner of the clean robot 130 in the action hot area HA1 can be a helical route, a S-shaped route, a Z-shaped route or random route.

More specifically, when the controller 120 finds out the action hot area HA1, it will set a cleaning path CP1 of the clean robot 130 according to the action hot area HA1. In this case, the action hot area HA1 can be the place where more than one moving objects often pass through, that means the action hot area HA1 is usually the place where the dust or hair easily accumulated. Therefore, the cleaning intensity of the cleaning path CP1 located inside the action hot area HA1 will be higher than outside the action hot area HA1. Herein, the moving object is organism or machinery which has the ability to move, for example, an animal or a mobile equipment, etc. . . . . In this way, the clean robot 130 can fully and effectively perform cleaning to the field FD1.

In the present embodiment of the invention, the clean robot 130 can preferentially clean the action hot area HA1. However, in other embodiments, the clean robot 130 can clean the outside area of the action hot area HA1 in advance which can be setup according to the system design. The present embodiment of the invention is not limited thereto.

In addition, through the image analysis, the controller 120 can determine whether there is an active moving object in the field FD1 according to the image of the image information DIM. Moreover, it can also determine the active time of the moving object in the field FD1 and the inactive time segment of the field FD1 through the image analysis. Next, after finding out the active time of the moving object in the field FD1, the controller 120 can instruct the clean robot 130 to clean the action hot area HA1 right after the active time. Furthermore, the cleaning time of the clean robot 130 can be adjusted according to the use status of the field FD1, that means when the field FD1 is not in use, the cleaning time of the clean robot 130 can be longer, while the field FD1 is in use, the cleaning time of the clean robot can be shorten appropriately.

After finding out the inactive time segment of the field FD1, the clean robot 130 can be instructed to clean the field FD1 within the inactive time segment, that means arranging the cleaning time of the clean robot 130 at the inactive time segment in order to avoid disturbing the activity of the moving object. Herein, the cleaning time of the clean robot 130 can be arranged before or after the normality active time (such as family time), but the embodiment of the invention is not limited thereto.

On the other hand, when the clean robot 130 is cleaning, the clean robot 130 can report its motion status to the controller 120 via mobile information IMV and report its power status to the controller 120 via power information IPO. When the mobile information IMV indicates the clean robot 130 as stop, the controller 120 determines a stop position of the clean robot 130 according to the image of the image information DIM. In addition, the controller 120 issues a warning message to prompt the stop position of the clean robot 130, wherein the warning message can be a voice message or a video message, but the embodiment of the invention is not limited thereto. When the power information IPO indicates the power status of the clean robot 130 is less than a low power value which means the clean robot 130 may be running out of power. Therefore, the controller 130 can indicate the clean robot 130 to return to the standby position, for example, the socket or charging dock, in order to charge.

In the present embodiment, the controller 120, for example, includes a motion detector unit 121, a storage unit 122, a hot area determining unit 123, a path defining unit 124, a control unit 125, and a scheduler unit 126. The motion detector unit 121 is used for detecting a motion trajectory of the moving object in the field FD1 according to the image of the image information DIM. The hot area determining unit 123 is used for determining the action hot area HA1 according to the motion trajectory. The storage unit 122 is used for storing the action hot area HA1. The path defining unit 124 is used for arranging the cleaning path CP1 of the clean robot 130 according to the action hot area HA1. The scheduler unit 126 is used for determining the inactive time segment (such as sleeping time or dining time) of the field FD1 according to the image of the image information DIM to arrange a cleaning time of the clean robot 130. The control unit 125 issues a control signal CMC to the clean robot 130 based on the cleaning time and the cleaning path in order to instruct the clean robot 130 to move and clean.

In the present embodiment, the motion detector unit 121, the storage unit 122, the hot area determining unit 123, the path defining unit 124, the control unit 125 and the scheduler unit 126 can be programs stored in the memory respectively and execute by the central processing unit. Or, the motion detector unit 121, the storage unit 122, the hot area determining unit 123, the path defining unit 124, the control unit 125 and the scheduler unit 126 can be the specific hardware circuits used for executing the corresponding circuit functions. In other word, the motion detector unit 121, the storage unit 122, the hot area determining unit 123, the path defining unit 124, the control unit 125 and the scheduler unit 126 can be all programs, all hardware circuits or the combination of programs and hardware circuits. It could be changed according to the requirement of the device design which is not particularly limited by the present embodiment of the invention.

The clean robot 130 includes a cleaner unit 131, a moving unit 132 and a communicator unit 133. The cleaner unit 131 is used for cleaning the field FD1. The moving unit 132 is used for moving the clean robot 130. The communicator unit 133 is coupled to the controller 120 to receive the control signal CMC transmitted by the controller 120 and report the operation status (such as the mobile information IMV and the power information IPO) of the clean robot 130 to the controller 120.

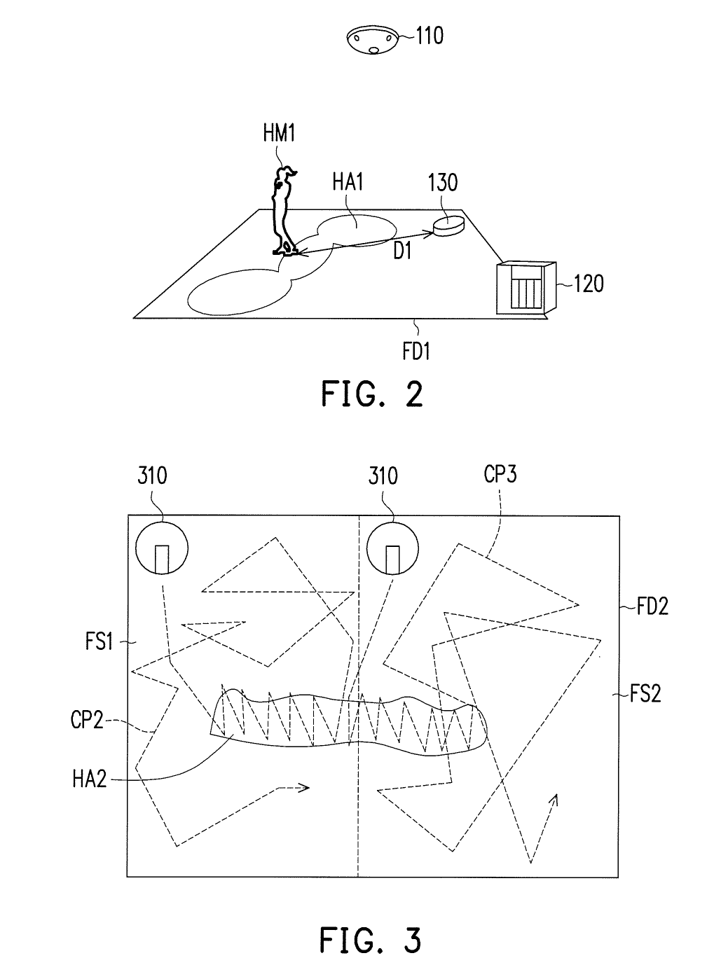

FIG. 2 is a schematic diagram illustrating a clean robot operating independently according to an embodiment of the invention. Referring to FIG. 1A, FIG. 1B and FIG. 2, wherein the identical or similar elements use the identical or similar numbering. In the present embodiment, if the clean robot 130 is cleaning and the moving object (taking a human HM1 for example) is in the field FD1, at this time, the controller 120 will detect the area of the action area of the human HM1 in the field FD1 according to the image of the image information DIM.

When the area of the action area of the human HM1 in the field FD1 is greater than or equal to a first threshold value (such as ⅕ of the area in the field FD1), the controller 120 instructs the clean robot 130 to return to a standby position. When the area of the action area of the human HM1 in the field FD1 is less than the first threshold value, the controller 130 analyzes the image of the image information DIM and computes a direct distance D1 between the clean robot 130 and the human HM1. In addition, the controller 130 determines a cleaning path (such as CP1) of the clean robot 130 according to the direct distance D1.

More specifically, when the direct distance D1 is less than a second threshold value (such as 2 meter), the controller 120 instructs the clean robot 130 to be away from the human HM1, that means the clean robot 130 will move in the opposite direction toward the human HM1 until the direct distance D1 is greater than the second threshold value instead of taking the cleaning path (such as CP1) at the moment into consideration. When the direct distance D1 is greater than or equal to the second threshold value and less than a third threshold value (such as 4 meter), the controller 120 considers the action area (for instance, the action hot area HA1) as an restricted area. In addition, the controller 120 divides outside the restricted area in the field FD1 into a plurality of first sub-areas, and then rearranges the cleaning sequences of the first sub-areas to determine the cleaning path (such as CP1) of the clean robot 130. Herein, the first sub-areas can be the same shape or different shapes and can also be the same area or different areas. Moreover, among the first sub-areas, the closer to the human HM1, then the later the cleaning sequences can be.

When the direct distance D1 is greater than or equal to the third threshold value, the controller 120 divides the field FD1 into a plurality of second sub-areas, and rearranges the cleaning sequences of the second sub-areas to determine the cleaning path (such as CP1) of the clean robot 130. Herein, the second sub-areas can be the same shape or different shapes and can also be the same area or different areas. Moreover, among the second sub-areas, the closer to the human HM1, then the later the cleaning sequences can be.

FIG. 3 is a schematic diagram illustrating a clean robot operating jointly according to an embodiment of the invention. Referring to FIG. 1A, FIG. 1B and FIG. 3, wherein the identical or similar elements use the identical or similar numbering. In the present embodiment, the entire field FD2 is divided into two blocks (that is FS1 and FS2). In addition, the clean robot 310 is mainly responsible for the block FS1 and the clean robot 320 is mainly responsible for the block FS2. When the controller 120 finds out the action hot area HA2 in the field FD2, it will control the clean robot 310 and 320 to clean the action hot area HA2 together and they are not limited by the block FS1 and FS2. Moreover, the controller 120 will set the cleaning path CP2 and CP3 of the clean robot 310 and 320 correspondingly.

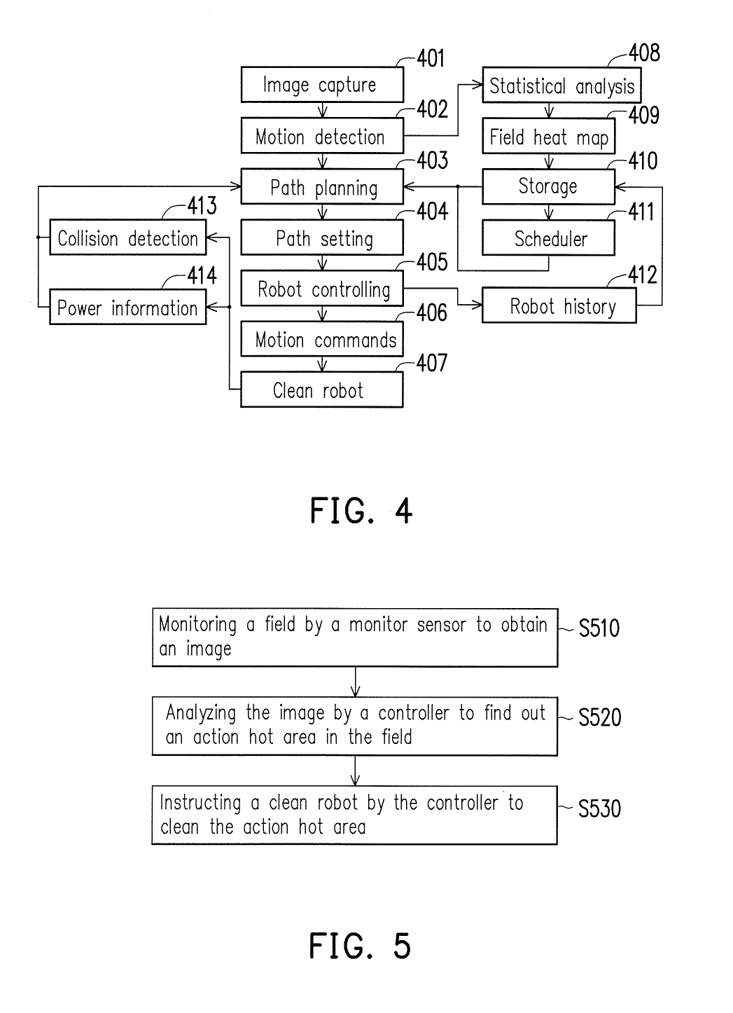

FIG. 4 is an operation schematic diagram illustrating an automatic cleaning system according to an embodiment of the invention. Referring to FIG. 4, in the present embodiment, it will capture the image to the field (function block 401) in advance, and then perform the motion detection on the image (function block 402). Moreover, it will perform the statistical analysis of the detection results (function block 408) to obtain the field heat map (function block 409). After storing the field heat map (function block 410), it will be the basis of the time schedule (function block 411). In addition, the path planning of the clean robot (function block 403) will refer to the stored the field heat map, the time schedule, the collision detection of the clean robot (function block 413) and the power information (function block 414). Next, the cleaning path is to be set (function block 404).

After setting the cleaning path, it will control the clean robot according to the cleaning path (function block 405), that means the clean robot will issue the motion commands (function block 406) to drive the clean robot (function block 407) start to move. Moreover, the clean robot history (function block 412) will be stored (function block 410) as well. After the clean robot moves, it will perform the detection of collision (function block 413) and the monitor of power information (function block 414).

FIG. 5 is a flow chart illustrating an operation method of an automatic cleaning system according to an embodiment of the invention. Referring to FIG. 5, in the present embodiment, the operation method of the automatic cleaning system includes the following steps. In this case, first of all, it will monitor a field by a monitor sensor to obtain an image (step S510), then analyze the image by a controller to find out an action hot area in the field (step S520). At last, it will instruct a clean robot by the controller to clean the action hot area (step S530).

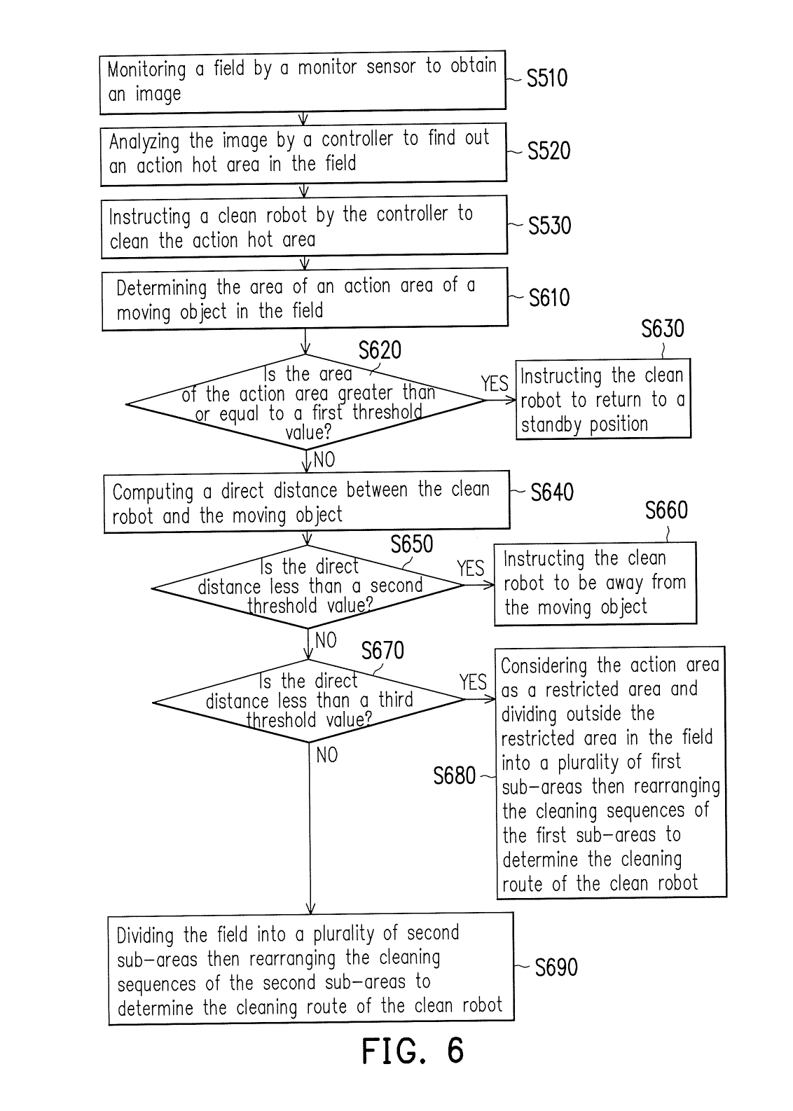

FIG. 6 is a flow chart illustrating an operation method of an automatic cleaning system according to another embodiment of the invention. Referring to FIG. 5 and FIG. 6, in which the identical or similar steps use the identical or similar numbering. In addition, the operation method of the automatic cleaning system further includes the following steps. That is to say, the controller analyzes the image to determine the area of an action area of a moving object in the field (step S610). Next, it determines whether the area of the action area of the moving object in the field is greater than or equal to a first threshold value (step S620). When the area of the action area of the moving object in the field is greater than or equal to the first threshold value, that means the determination result of the step S620 is “YES”, then the controller instructs the clean robot to return to a standby position (step S630). When the area of the action area of the moving object is less than the first threshold value, that means the determination result of the step S620 is “NO”, then the controller analyzes the image to compute a direct distance between the clean robot and the moving object (step S640).

Next, it computes whether the direct distance is less than a second threshold value (step S650). When the direct distance is less than the second threshold value, that means the determination result of the step S650 is “YES”, then the controller instructs the clean robot to be away from the moving object (step S660). When the direct distance is greater than or equal to the second threshold value, that means the determination result of the step S650 is “NO”, then it computes whether the direct distance is less than a third threshold value (step S670). When the direct distance is less than the third threshold value, that means the determination result of the step S670 is “YES”, then the controller considers the action area as a restricted area, and divides outside the restricted area in the field into a plurality of first sub-areas. And then the controller rearranges the cleaning sequences of the first sub-areas to determine the cleaning path of the clean robot (step S680). When the direct distance is greater than or equal to the third threshold value, that means the determination result of the step S670 is “NO”, then the controller divides the field into a plurality of second sub-areas. In addition, the controller rearranges the cleaning sequences of the second sub-areas to determine the cleaning path of the clean robot (step S690). Herein, the sequences of the step S510, S520, S530, S610, S620, S630, S640, S650, S660, S670, S680 and S690 are used for explanation which should not be construed as a limitation to the invention. Moreover, the details of the step S510, S520, S530, S610, S620, S630, S640, S650, S660, S670, S680 and S690 can refer to the embodiments illustrating in FIG. 1A, FIG. 1B, FIG. 2 and FIG. 3 which are not repeated hereinafter.

In summary, an automatic cleaning system and operation method thereof in the present embodiment of the invention through a monitor sensor to obtain an image of a field and through a controller to find out an action hot area in the field and then the controller instructs a clean robot to clean the action hot area. In this way, the clean robot can fully and effectively perform cleaning to the field and cleaning paths of the clean robot can be more flexible. Moreover, the clean robots can collaborate by controlling the controller and avoiding disturbing the motion of the moving object.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An automatic cleaning system, comprising:
a monitor sensor, disposed on a field, used for monitoring the field to obtain an image;
a clean robot; and
a controller, coupled to the monitor sensor to receive the image, used for analyzing the image to find out an action hot area, and instructing the clean robot to clean the action hot area.

2. The automatic cleaning system as recited in claim 1, wherein when an area of an action area of at least one moving object in the field is greater than or equal to a first threshold value, the controller instructs the clean robot to return to a standby position, and when the area of the action area of the at least one moving object is less than the first threshold value, the controller analyzes the image to computes a direct distance between the clean robot and the at least one moving object, and determines a cleaning path of the clean robot according to the direct distance.

3. The automatic cleaning system as recited in claim 2, wherein when the direct distance is less than a second threshold value, the controller instructs the clean robot to be away from the at least one moving object, when the direct distance is greater than or equal to the second threshold value and less than a third threshold value, the controller considers the action area of the at least one moving object as a restricted area, and divides outside the restricted area in the field into a plurality of first sub-areas then rearranges the cleaning sequences of the first sub-areas to determine the cleaning path of the clean robot, when the direct distance is greater than or equal to the third threshold value, the controller divides the field into a plurality of second sub-areas, and rearranges the cleaning sequences of the second sub-areas to determine the cleaning path of the clean robot.

4. The automatic cleaning system as recited in claim 2, wherein the at least one moving object comprises at least one animal.

5. The automatic cleaning system as recited in claim 1, wherein the controller comprises:
a motion detector unit, used for detecting a motion trajectory of at least one moving object in the field according to the image;
a hot area determining unit, used for determining the action hot area according to the motion trajectory;
a storage unit, used for storing the action hot area;
a scheduler unit, used for determining an inactive time segment of the field according to the image to arrange a cleaning time of the clean robot;
a path defining unit, used for arranging the cleaning path of the clean robot according to the action hot area; and
a control unit, issuing a control signal to the clean robot based on the cleaning time and the cleaning path in order to instruct the clean robot.

6. The automatic cleaning system as recited in claim 1, wherein the controller determines an inactive time segment of the field according to the image, and instructs the clean robot to clean the field within the inactive time segment.

7. The automatic cleaning system as recited in claim 1, wherein the clean robot reports a motion status to the controller, when the motion status indicates the clean robot as stop, the controller determines a stop position of the clean robot according to the image, and issues a warning message to prompt the stop position.

8. The automatic cleaning system as recited in claim 1, wherein the clean robot reports a power status to the controller, when the power status is less than a low power value, the controller instructs the clean robot to return to a standby position.

9. The automatic cleaning system as recited in claim 1, wherein the clean robot comprises:
a cleaner unit, used for cleaning the field;
a moving unit, used for moving the clean robot; and
a communicator unit, coupled to the controller to receive a control signal transmitted by the controller, and return an operation status of the clean robot.

10. An operation method of an automatic cleaning system, comprising:
through a monitor sensor monitoring a field to obtain an image;
through a controller analyzing the image to find out an action hot area in the field; and
through the controller instructing a clean robot to clean the action hot area.

11. The operation method of the automatic cleaning system as recited in claim 10, further comprising:
when an area of an action area of at least one moving object in the field being greater than or equal to a first threshold value, the controller instructing the clean robot to return to a standby position; and
when the area of the action area of the at least one moving object being less than the first threshold value, the controller analyzing the image to compute a direct distance between the clean robot and the at least one moving object, and the controller determining a cleaning path of the clean robot according to the direct distance.
